(19) United States
(12) Patent Application Publication
(10) Pub. No.: US 2009/0102947 A1
(43) Pub. Date: Apr. 23, 2009

(54) SYSTEM AND METHOD FOR AUTOMATICALLY ADDING USER INFORMATION TO DIGITAL IMAGES

(75) Inventor: QING-FA OU, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Taipei Hsien (TW)

(21) Appl. No.: 11/964,854

(22) Filed: Dec. 27, 2007

(30) Foreign Application Priority Data
Oct. 23, 2007 (CN) 200710202224.0

(51) Int. Cl. H04N 5/76

(52) U.S. Cl. 348/231.99

(57) ABSTRACT

A method for automatically adding user information to digital images is disclosed. The method includes the steps of: loading user information to an inner storage of a digital camera; reading the user information from the inner storage; editing the user information stored in the inner storage, and storing the edited user information in the inner storage; adding the user information to a header of an EXIF file of a digital image, then the user information is automatically added to a digital image at the time when the digital image is captured by the digital camera. A related system is also disclosed.

### BACKGROUND OF THE INVENTION

1. Field of the Invention

The present invention is related to a system and method for automatically adding user information to digital images.

2. Description of Related Art

Recently, digital cameras have been in widespread used in place of analog cameras. The advantages of the digital cameras are as follows.

Digital images can be directly viewed on a display device such as a Liquid Crystal Display (LCD) of a digital camera. Digital images can be deleted as desired. Digital images can be stored in a personal computer (hereinafter referred to as “PC”) to be processed and edited with ease. Printing of digital images is available by means of a printer, and the digital images can be transmitted as digital files. By transferring digital images to a PC, digital images can be stored without degradation.

For these reasons, digital cameras have become very popular. Further, in digital cameras, the number of pixels has increased with advances in Charge Coupled Device (CCD) technology. For example, digital cameras having 2 to 3 mega pixels or more, are now on sale.

Conventionally, the date can be displayed automatically in a digital image, but user information (such as the name of the owner or user of the digital camera) cannot be automatically displayed in the digital image. User information can be added to digital images with the aid of image editing application software in a PC or printer.

Therefore, what is needed is a system and method for automatically adding user information to digital images in a digital camera.

### SUMMARY OF THE INVENTION

A system for automatically adding user information to digital images is provided in accordance with a preferred embodiment. The system includes a digital camera. The digital camera has an inner storage and a user information management unit. The user information management unit includes a loading module, a reading module, and an EXIF information setting module. The loading module is configured for loading user information from an external storage to the inner storage. The reading module is configured for reading the user information from the inner storage. The EXIF information setting module is configured for adding the user information in a header of an EXIF file of a digital image, then the user information is automatically added to the digital image at the time when the digital image is captured by the digital camera.

A method for automatically adding user information to digital images is also provided. The method includes the steps of: loading user information from an external storage to an inner storage of a digital camera; reading the user information from the inner storage; adding the user information in a header of an EXIF file of a digital image, then the user information is automatically added to the digital image at the time when the digital image is captured by the digital camera.

Other systems, methods, features, and advantages of the present invention will become apparent to one with skill in the art upon examination of the following drawings and detailed description.

### BRIEF DESCRIPTION OF THE DRAWINGS

FIG. 1 is a schematic diagram of hardware configuration of a system for automatically adding user information to digital images in accordance with a preferred embodiment; and

FIG. 2 is a flowchart of a preferred method for automatically adding user information to digital images in accordance with one embodiment.

### DETAILED DESCRIPTION OF THE INVENTION

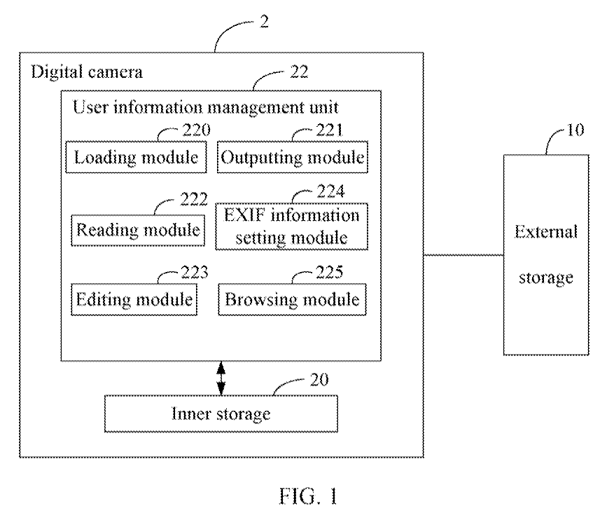

FIG. 1 is a schematic diagram of hardware configuration of a system for automatically adding user information to digital images (hereinafter, “the system”) in accordance with a preferred embodiment. The system typically includes a digital camera 2. The digital camera 2 includes an inner storage 20, and can be attached to an external storage 10. The external storage 10 may be a kind of outside card that can exchange data with the digital camera 2 such as a Secure Digital (SD) card. The inner storage 20 may be a Synchronous Dynamic Random Access Memory (SDRAM) or any other suitable kind of storage device. The digital camera 2 may further include a user information management unit 22. The user information management unit 22 may include a loading module 220, an outputting module 221, a reading module 222, an editing module 223, an EXIF information setting module 224, and a browsing module 225.

The loading module 220 is configured for loading user information from the external storage 10 to the inner storage 20. The user information may include, but is not limited to, name, address, and phone number of a user of the digital camera 2.

The outputting module 221 is configured for outputting the user information to the external storage 10 from the inner storage 20.

The reading module 222 is configured for reading the user information from the inner storage 20.

The editing module 223 is configured for editing the user information stored in the inner storage 20 using keys (such as a left key, a right key, an upward key, a downward key, and an “OK” key) on the digital camera 2 if necessary, and storing the edited user information in the inner storage 20. If the user information to be edited is in the external storage 10, the loading module 220 can be used to load the user information to the inner storage 20 from the external storage 10. If there is a need to store the edited user information in the external storage 10, the outputting module 221 can be used to output the edited user information to the external storage 10 from the inner storage 20. The edited user information can be stored in the external storage 10 in a specified format such as an Extensible Markup Language (XML) format.

The EXIF information setting module 224 is configured for adding the user information in a header of an Exchangeable Image File (EXIF) file. The EXIF format is a standard format for displaying digital images. Accordingly, the reading module 222 reads the user information from the header of the EXIF file, and automatically adds the user information to a digital image at the time when the digital image is captured by the digital camera 2. The user information can be displayed in the digital image when the digital image is viewed such as with the aid of image editing application software (such as ACDSee) on a PC.

The browsing module 225 is configured for browsing the user information stored in the inner storage 20 of the digital camera 2. For example, the user name can be easily found through browsing the user information stored in the digital camera 2.

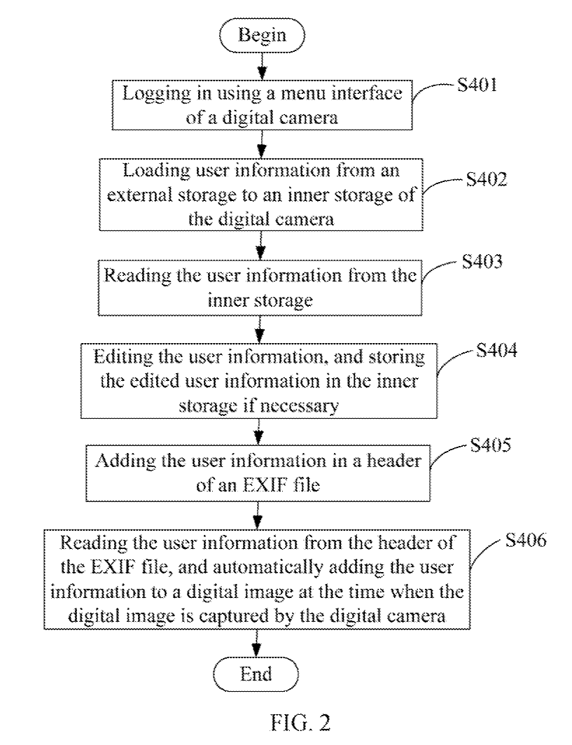

FIG. 2 is a flowchart of a preferred method for automatically adding user information to digital images in accordance with one embodiment. In step S401, a user logs in using a menu interface of the digital camera 2.

In step S402, the loading module 220 loads user information from the external storage 10 to the inner storage 20. The user information may include the user name of the digital camera 2, the telephone number of the user, and the address of the user.

In step S403, the reading module 222 reads the user information from the inner storage 20.

In step S404, the editing module 223 edits the user information stored in the inner storage 20 using one or more keys (such as the left key, the right key, the upward key, the downward key, and the “OK” key) on the digital camera 2 if necessary, and stores the edited user information in the inner storage 20. If the user information needs to be edited and is stored in the external storage 10, the loading module 220 can be used to load the user information to the inner storage 20 from the external storage 10. If there is a need to store the edited user information in the external storage 10, the outputting module 221 can be used to output the edited user information to the external storage 10 from the inner storage 20. The edited user information can be stored in the external storage 10 in a specified format such as the Extensible Markup Language (XML) format. Before the user information is edited, the browsing module 225 can be used to browse the user information stored in the inner storage 20 of the digital camera 2.

In step S405, the EXIF information setting module 224 adds the user information to the header of the EXIF file.

In step S406, the reading module 222 reads the user information from the header of the EXIF file, and automatically adds the user information to the digital image at the time when the digital image is captured by the digital camera 2. The user information can be displayed in the digital image when the digital image is viewed such as with the aid of image editing application software on the PC.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for automatically adding user information to digital images, the system comprising a digital camera, the digital camera having an inner storage and a user information management unit, the user information management unit comprising:
a loading module configured for loading user information from an external storage to the inner storage;
a reading module configured for reading the user information from the inner storage; and
an EXIF information setting module configured for adding the user information in a header of an EXIF file; wherein
the reading module is configured for reading the user information from the header of the EXIF file, and automatically adding the user information to a digital image at the time when the digital image is captured by the digital camera.

2. The system according to claim 1, wherein the user information includes a user name of the digital camera, a telephone number of the user, and an address of the user.

3. The system according to claim 1, wherein the user information management unit further comprises an editing module configured for editing the user information stored in the inner storage, and storing the edited user information in the inner storage.

4. The system according to claim 1, wherein the user information management unit comprises an outputting module configured for outputting the user information to the external storage from the inner storage according to an XML format.

5. The system according to claim 1, wherein the user information management unit further comprises a browsing module configured for browsing the user information stored in the digital camera.

6. A method for automatically adding user information to digital images, the method comprising:
loading user information from an external storage to an inner storage of a digital camera;
reading the user information from the inner storage;
adding the user information in a header of an EXIF file; and
reading the user information from the header of the EXIF file, and automatically adding the user information to a digital image at the time when the digital image is captured by the digital camera.

7. The method according to claim 6, wherein the user information includes a user name of the digital camera, a telephone number of the user, and an address of the user.

8. The method according to claim 6, further comprising:
editing the user information stored in the inner storage, and storing the edited user information in the inner storage.

9. The method according to claim 6, further comprising:
outputting the user information to the external storage from the inner storage according to an XML format.
